(19) United States
(12) Patent Application Publication
(10) Pub. No.: US 2008/0242570 A1
(43) Pub. Date: Oct. 2, 2008

(54) LIQUID COMPOSITION SYSTEM HAVING A VISUAL INDICATION CHANGE

(76) Inventors: John David Carter, Mason, OH (US); Richard Timothy Hartshorn, Lawrenceburg, IN (US); Corinne Daumer, Strombeek (BE); Sharon McIntyre, Sunderland (GB)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/054,485

(22) Filed: Mar. 25, 2008

Related U.S. Application Data
(60) Provisional application No. 60/919,992, filed on Mar. 26, 2007.
(60) Provisional application No. 61/021,665, filed on Jan. 17, 2008.

(51) Int. Cl. C11D 3/40

(52) U.S. Cl. 510/100

(57) ABSTRACT

A detergent composition having a pH dye and an amphoteric surfactant that changes color when added to a volume of water.

### CROSS REFERENCE TO RELATED APPLICATION

The present application claims priority under 35 U.S.C. 119(e) to U.S. Application Ser. No. 60/919,992, filed on Mar. 26, 2007 and U.S. Application Ser. No. 61/021,665, filed on Jan. 17, 2008.

### FIELD OF THE INVENTION

The present invention relates to a liquid detergent composition having a visual indication change when added to a volume of water. The invention further relates to a method of using and a process of instructing the use of such a liquid detergent composition.

### BACKGROUND OF THE INVENTION

Consumers look for new and interesting signals to assist them in their cleaning actions. The use of a color change is a visual indication that can be used to tell the consumer that something is occurring that they may not normally be aware. The use of pH indicators in cleaning products has been discussed in the context of increasing pH (from acidic pHs to a pH of 6.5 or neutral pHs). See GB 1,313,180, EP 0 225 978, FR2673640 and U.S. Pat. No. 4,863,620.

Utilizing an acidic pH is not a viable option when utilizing more acidic pH liquid compositions for grease cleaning, preferably liquid compositions comprising surfactants such as amine oxides which require alkaline pH to have stability in liquid detergent compositions. A liquid detergent composition comprising amine oxides that decreases pH (basic pHs to neutral pHs) during use requires a different system and poses distinct formulation issues compared to acidic pH indicators. Having a color change is preferred to a colorless end point (GB 1424714). Other known ways of having a color change include mixing a separate component with the pH indicator just prior to use in order to give the desired color change. See U.S. Pat. No. 7,053,029 and U.S. Pat. No. 3,650,831. However, keeping components separated or requiring consumers to mix components together before use are equally undesirable in terms of cost or convenience.

Another problem posed by the addition of components such as dyes to a liquid detergent composition, more specifically an excess of dyes, can change the appearance of the composition making the composition appear too dark to a consumer such that light cannot be seen easily through the composition when the composition is contained within a clear container.

Therefore there still exists a need for a neutral or basic liquid detergent composition having a pH of from 7.5 to 13 to provide a visual indication change, preferably a visible color change upon dilution in a volume of water such that a blue or green color is perceived.

### SUMMARY OF THE INVENTION

The present invention relates to a liquid composition system comprising: (a) a liquid composition with a pH of from 7.5 to 13 comprising: (i) a pH dye capable of a first visual indication and capable of a second visual indication; (ii) an amine oxide surfactant; and (b) a volume of water; wherein the liquid composition comprising the first visual indication of the pH dye and when the liquid composition is diluted in a volume of water forming a liquid composition system and the liquid composition system comprises the second visual indication of the pH dye.

The present invention further relates to a method of producing a color change in a liquid detergent composition by providing a liquid composition with a pH of from 7.5 to 13 having a first visual color comprising: (i) a pH sensitive dye; (ii) an amine oxide surfactant; such that when the liquid detergent composition is added to a volume of water a second visual color results.

The present invention further relates to a process of producing a visual change in the color of a liquid composition comprising the steps of: (a) providing a liquid composition with a pH of from 7.5 to 13 having a first visual color comprising: (i) a pH sensitive dye; (ii) an amine oxide surfactant; (b) providing instructions to add the liquid composition to a volume of water; and (c) communicating that the mixture resulting from the liquid composition and volume of water results a second visual color.

### DETAILED DESCRIPTION OF THE INVENTION

As used herein “liquid dishwashing detergent composition” refers to those compositions that are employed in manual (i.e., hand) dishwashing and any solutions containing the composition in a diluted form. Such compositions are generally high sudsing or foaming in nature.

As used herein “laundry detergent composition” refers to those compositions that are employed in washing clothing and other fabrics and any solutions containing the composition in a diluted form. Such compositions are generally low sudsing or foaming in nature.

As used herein “volume of water” refers to a volume of water that is sufficient for rinsing or washing actions in a container such as a bucket or sink, that volume being from about 2000 ml. to about 20000 ml., more typically from about 5000 ml. to about 15000 ml. of water in a container such as a bucket or sink having a volumetric capacity in the range of from about 1000 ml. to about 20000 ml., more typically from about 5000 ml. to about 15000 ml. The water may be from any water source, for example any municipal, commercial, household or other available water sources. The pH of the volume of water preferably is from 6 to 9, more preferably from 6.5 to 9.

The liquid detergent composition may be added any volume of the liquid detergent composition to a volume of water, preferably from about 0.5 mL to about 20 mL of the liquid detergent composition to the volume of water. Preferably the concentration of the liquid detergent composition upon dilution is about 800 to about 5000 ppm.

Incorporated and included herein, as if expressly written herein, are all ranges of numbers when written in a “from X to Y” or “from about X to about Y” format. It should be understood that every limit given throughout this specification will include every lower or higher limit, as the case may be, as if such lower or higher limit was expressly written herein. Every range given throughout this specification will include every narrower range that falls within such broader range, as if such narrower ranges were all expressly written herein.

Unless otherwise indicated, weight percentage is in reference to weight percentage of the detergent composition. All temperatures, unless otherwise indicated are in Celsius. All documents cited are, in relevant part, incorporated herein by reference.

The compositions of the present composition are preferably suitable for use in cleaning hard surfaces, for example any kind of surfaces typically found in houses like kitchens, bathrooms, or in car interiors or exteriors, e.g., floors, walls, tiles, windows, sinks, showers, shower plastified curtains, wash basins, WCs, dishes, fixtures and fittings and the like made of different materials like ceramic, vinyl, no-wax vinyl, linoleum, melamine, glass, any plastics, plastified wood, metal or any painted or varnished or sealed surface and the like. Hard-surfaces also include household appliances including, but not limited to, refrigerators, freezers, washing machines, automatic dryers, ovens, microwave ovens, dishwashers and so on.

In one preferred embodiment the composition is suitable for cleaning dishware including dishes, cups, cutlery, glassware, food storage containers, cutlery, cooking utensils, sinks and other kitchen surfaces. In another preferred embodiment the composition is suitable for cleaning fabrics including clothing, towels, sheets, drapery, rugs, and other cloth items.

The composition may be in any suitable liquid form or semi-liquid form like gels, liquids or a unit dose form such as tablets, capsules or combinations of any of these forms. In one embodiment the composition is in liquid form. In another embodiment the composition is in a liquid aqueous form.

pH—The liquid composition has a pH from 7.5 to 13, preferably 8.0 to 10, more preferably from 8.5 to 9.5 as measured as 10% aqueous solution of distilled water. The pH is measured at room temperature (20° C.) with a standard pH probe where the liquid composition is diluted to a 10% aqueous solution. This dilution for measuring pH, however, is not intended to be the liquid composition system discussed herein.

pH dye—pH dye or pH sensitive dye, possibly two or more pH dyes, for use in the present application is one that gives a visual indication change, preferably a color change. The amount of pH dye in the composition may be from about 25 ppm to about 500 ppm, preferably 30 ppm to 200 ppm, preferably from 35 ppm to 75 ppm.

The pH dye(s) may be selected from Formula A:

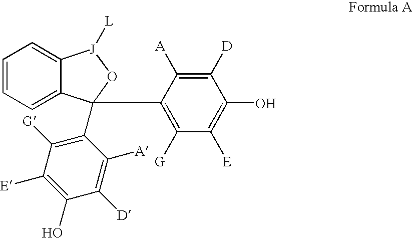

A and A′ are independently selected from hydrogen, linear or branched C₁-C₁₂ alkyl, preferably selected from hydrogen and methyl (C₁ alkyl), more preferably, A and A′ are selected as both hydrogen or both methyl (C₁ alkyl). D and D′ are independently selected from hydrogen, linear or branched C₁-C₁₂ alkyl, chlorine (C₁) and bromine (Br), preferably D and D′ are selected from hydrogen, branched C₃ alkyl (isopropyl), chlorine (Cl) and bromine (Br), more preferably D and D′ are both selected as hydrogen, branched C₃ alkyl (isopropyl), chlorine (Cl) or bromine (Br). E and E′ are independently selected from hydrogen, linear or branched C₁-C₁₂ alkyl, chlorine (Cl) and bromine (Br), preferably E and E′ are selected from hydrogen, methyl (Cl alkyl), branched C₃ alkyl (isopropyl) and bromine (Br), more preferably E and E′ are both selected as hydrogen, methyl (C₁ alkyl), branched C₃ alkyl (isopropyl) and bromine (Br). G and G′ are independently selected from hydrogen, chlorine (Cl) or bromine (Br), preferably G and G′ are selected from hydrogen and bromine (Br), most preferably G and G′ are both selected as hydrogen or bromine (Br). J-L is a —C═O (carbon double bonded to oxygen) or —SO₂ moiety. Further linear or branched C₁-C₁₂ alkyl that are not already listed above are methyl (—CH₃), ethyl (—C₂H₅), isopropyl (—CH(CH₃)₂), butyl (—C₄H₉), isobutyl (—CH(CH₃)(C₂H₅)).

The pH dye(s) may be selected from the salts of Formula A shown below as Formula B:

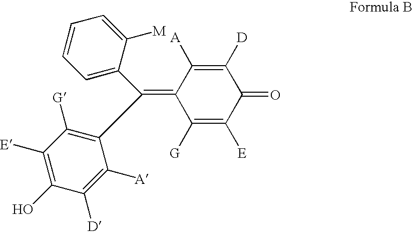

A and A′, D and D′, E and E′ and G and G′ of Formula B are as described above in Formula A. M of Formula B is selected from SO₃⁻, CO₂⁻ and mixtures thereof.

The pH dye may be selected from the group of bromocresol purple (reported pKa of 6.3 @ 25° C.), bromothymol blue (reported pKa of 7.1 @ 25° C.), bromocresol green (reported pKa of 4.7 @ 25° C.), bromophenol blue (reported pKa of 4.0 @ 25° C., bromoxylenol blue (reported pKa of 7.0 @ 25° C.) and mixtures thereof. Likewise, the salts of these pH dyes may also be utilized. It is believed that selecting a pH dye comprising an apparent pKa close to the pH of the liquid composition system gives the most noticeable visual indication change from the first visual indication to the second visual indication.

The apparent pKa at 25° C., as used herein, means the range of pKa values where the pH dye changes from one visual indication to a second visual indication when sulfate or sulphonate surfactants are present. Without being limited by a theory, it is believed that the association of the pH dye with the micelles of surfactant, more with anionic surfactants than other types of surfactants, causes the pKa (“apparent pKa”) of a pH dye to increase proportionate to the surfactant level than reported pKas of pH dyes. J. Chem. Soc. Faraday Trans., 1995, Vol. 91, Issue 4, pages 681-686; Colloids and Surfaces A: Physicochem. Eng. Aspects, Vol. 216 (2003) pgs. 21-26; Journal of Colloid and Interface Science, Vol. 285 (2005), pages 382-387.

As used herein “visual indication” means a visual cue or visual color. Preferably the first visual indication or visual color is one color and the second visual indication or visual color is a second color. Preferably the first color is selected from colorless (lack of color), blue, green, purple, pink, red, orange and yellow. In one embodiment, the first visual indication is a color characterized by a solution absorption wavelength interval of λmax=about 380 nm to about 700 nm.

The second visual indication is a color characterized by a solution absorption wavelength interval of λmax=550 to about 680 nm. Preferably the second color is selected from blue. Without being limited by a theory, it is believed that the second visual indication wavelengths, which correspond to the visual appearance of blue color for the solution, indicate to users of the composition that the volume of water is “clean” and may still be utilized to wash or rinse items being cleaned or rinses.

As used herein “providing” means making an item such as the liquid composition or instructions available to person who will then utilize the item, such as making the item available in consumer stores or in virtual stores such as one can find on the internet. Instructions may mean written, pictorial or verbal instructions to communicate that the liquid composition is to be added to a volume of water. The instructions may include other information such as the amount of water, temperature of the water or any other information that may be relevant to the process of the present application. “Communicating” means in the process of the present application is any written, pictorial or verbal information to the person who will then utilize the communicated information for its intended purpose. The communication may come in the form of advertising, internet website, label language on a containing having the liquid composition and similar types of communication that would be understood by someone interacting with the communication.

The timing of the change from the first visual indication to the second indication should be completed in less than one minute (60 seconds) from the time the liquid detergent composition is added to the volume of water. Preferably the change from the first visual indication to the second indication is perceived in less than thirty seconds, preferably in less than 20 seconds, preferably less then 10 seconds.

The second visual indication should be present for at least 30 second, preferably at least 60 seconds up to 30 minutes. The second visual indication preferably is persistent in the presence of soils that may accumulate in the volume of water as surfaces are cleaned.

Further dyes—in addition to the pH dye, other standard dyes may be used to achieve the desired visual indication in either the liquid composition or liquid composition system. For example, the pH dye may give a visual indication of a green color, but it is desired to have a “deeper” or more vibrant shade of green. In such a case, a further dye or combination of dyes (a blue dye and a yellow dye, for example) may be added to achieve the desired visual color.

### Amine Oxide Surfactants

Amine oxides are semi-polar nonionic surfactants and include water-soluble amine oxides containing one alkyl moiety of from about 10 to about 18 carbon atoms and 2 moieties selected from the group consisting of alkyl groups and hydroxyalkyl groups containing from 1 to 3 carbon atoms; water-soluble phosphine oxides containing one alkyl moiety of from 10 to 18 carbon atoms and 2 moieties selected from the group consisting of alkyl groups and hydroxyalkyl groups containing from about 1 to about 3 carbon atoms; and water-soluble sulfoxides containing one alkyl moiety of from about 10 to about 18 carbon atoms and a moiety selected from the group consisting of alkyl and hydroxyalkyl moieties of from 1 to 3 carbon atoms. Preferred amine oxide surfactants in particular include C₁₀-C₁₈ alkyl dimethyl amine oxides and C₈-C₁₂ alkoxy ethyl dihydroxy ethyl amine oxides.

The amine oxide surfactant is present in the composition in an effective amount such as from about 0.1% to about 40%, further such as about 0.1% to about 20%, even further such as about 0.5% to about 15% by weight of the composition.

### Optional Ingredients

The compositions of the present composition may also comprise optional ingredients for example other surfactants than amine oxide surfactants, hydrotrope, viscosity modifier, diamine, polymeric suds stabilizer, enzymes, builder, perfume, chelating agent and mixtures thereof. The type or form of the composition, whether it is a liquid dishwashing detergent composition, a hard surface cleaning composition, a rinse added composition, a laundry detergent composition, among others dictates the appropriate type of optional ingredients. One of skill in the art is able to select the appropriate optional ingredients for the composition herein.

### Other Surfactants

The detergent compositions of the present composition may comprise other surfactants than the amine oxide discussed above. Other surfactants may be selected from the group consisting of amphoteric (other than the amine oxide surfactants), zwitterionic, nonionic, anionic surfactants, cationic surfactants and mixtures thereof. Suitable such surfactants are those commonly used in detergent compositions.

### Amphoteric Surfactants

Other suitable, non-limiting examples of amphoteric detergent surfactants (other than the amine oxide surfactants) that are useful in the present composition include amido propyl betaines and derivatives of aliphatic or heterocyclic secondary and ternary amines in which the aliphatic moiety can be straight chain or branched and wherein one of the aliphatic substituents contains from 8 to 24 carbon atoms and at least one aliphatic substituent contains an anionic water-solubilizing group.

The amphoteric surfactant, when present, is present in the composition in an effective amount such as from about 0.1% to about 40%, further such as about 0.1% to about 20%, even further such as about 0.5% to about 15% by weight of the composition.

### Anionic Surfactants

The anionic surfactant, when present, is at a level of at least 15%, such as from 20% to 40% and further from 25% to 40% by weight of the composition. Anionic surfactants when utilized as components of the compositions of the present application may be suitable anionic surfactants selected from water-soluble salts or acids of C₆-C₂₀ linear or branched hydrocarbyl, such as an alkyl, hydroxyalkyl or alkylaryl, having a C₁₀-C₂₀ hydrocarbyl component, more preferably a C₁₀-C₁₄ alkyl or hydroxyalkyl, sulphate or sulphonates, C₁₀-C₁₈ alkyl alkoxy carboxylates preferably comprising 1-5 ethoxy units. Suitable counterions include hydrogen, alkali metal cation or ammonium or substituted ammonium, further sodium.

Sulfate Or Sulphonate Surfactant—Preferred sulphonate surfactants are the alkali metal salts of C₁₀₋₁₆ alkyl benzene sulfonic acids, preferably C₁₁₋₁₄ alkyl benzene sulfonic acids. Preferably the alkyl group is linear and such linear alkyl benzene sulfonates are known as “LAS”. Alkyl benzene sulfonates, and particularly LAS, are well known in the art. Such surfactants and their preparation are described for example in U.S. Pat. Nos. 2,220,099 and 2,477,383. Especially preferred are the sodium and potassium linear straight chain alkylbenzene sulfonates in which the average number of carbon atoms in the alkyl group is from about 11 to 14. Sodium C₁₁₋₁₄, e.g., C₁₂, LAS is especially preferred.

Another preferred type of sulfate surfactant comprises ethoxylated alkyl sulfate surfactants. Such materials, also known as alkyl ether sulfates or alkyl polyethoxylate sulfates, are those which correspond to the formula (I)

R′—O—(C₂H₄O)ₙ—SO₃M (formula (I))

wherein R′ of formula (I) is a C₈-C₂₀ alkyl group, n of formula (I) is from about 1 to 20, and M of formula (I) is a salt-forming cation. Preferably, R′ formula (I) is C₁₀-C₁₈ alkyl, n formula (I) is from about 1 to 15, and M formula (I) is sodium, potassium, ammonium, alkylammonium, or alkanolammonium. Most preferably, R′ formula (I) is a C₁₂-C₁₆, n formula (I) is from about 1 to 6 and M formula (I) is sodium.

The alkyl ether sulfates will generally be used in the form of mixtures comprising varying R′ chain lengths and varying degrees of ethoxylation. Frequently such mixtures will inevitably also contain some unethoxylated alkyl sulfate materials, i.e., surfactants of the above ethoxylated alkyl sulfate formula wherein n=0. Unethoxylated alkyl sulfates may also be added separately to the compositions of this invention and used as or in any anionic surfactant component which may be present.

Preferred unalkoxylated, e.g., unethoxylated, alkyl ether sulfate surfactants are those produced by the sulfation of higher C₈-C₂₀ fatty alcohols. Conventional primary alkyl sulfate surfactants have the general formula (II):

ROSO₃⁻M⁺ formula (II)

wherein R of formula (II) is typically a linear C₈-C₂₀ hydrocarbyl group, which may be straight chain or branched chain, and M of formula (II) is a water-solubilizing cation. Preferably R of formula (II) is a C₁₀-C₁₅ alkyl, and M of formula (II) is alkali metal. Most preferably R of formula (II) is C₁₂-C₁₄ and M of formula (II) is sodium.

The liquid detergent composition may further comprise alkyl glyceryl sulphonate surfactants. Alkyl glyceryl sulphonate surfactants generally used have high monomer content (greater than 60 wt %). In one embodiment, it has been found that for starch cleaning, monomer content preferably is minimized and oligomer content maximized. As used herein “oligomer” includes dimer, trimer, quadrimer, and oligomers up to heptamers of alkyl glyceryl sulfonate surfactant. Minimization of the monomer content may be from 0 wt % to about 60 wt %, from 0 wt % to about 55 wt %, from 0 wt % to about 50 wt %, from 0 wt % to about 30 wt %, by weight of the alkyl glyceryl sulfonate surfactant present.

The alkyl glyceryl sulfonate surfactant for use herein include such surfactants having an alkyl chain length from C₁₀₋₄₀, C₁₀₋₂₂, C₁₂₋₁₈, and C₁₆₋₁₈. The alkyl chain may be branched or linear, wherein when present, the branches comprise a C₁₋₄ alkyl moiety, such as methyl (C₁) or ethyl (C₂). Generally, the structures of suitable alkyl glyceryl sulfonate surfactant oligomers that may be used herein include (A) dimers; (B) trimers, and (C) tetramers and higher oligomers not exemplified specifically below:

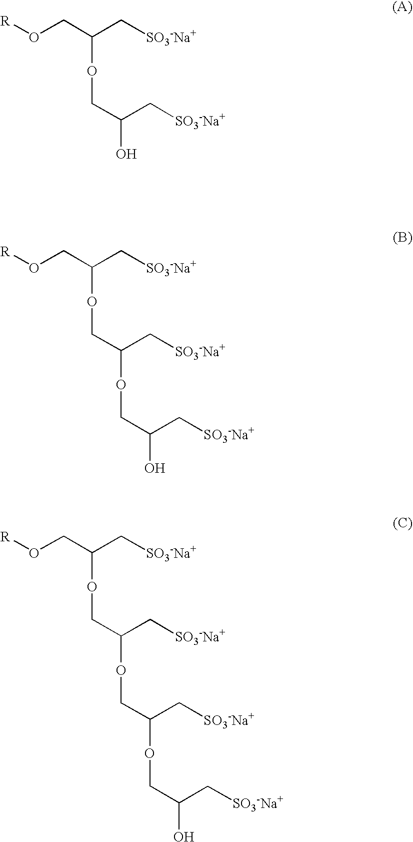

One of skill in the art will recognize that the counter-ion may be substituted with other suitable soluble cations other than the sodium shown above. R in the above structures (A)-(C) is from C₁₀₋₄₀, C₁₀₋₂₂, C₁₂₋₁₈, and C₁₆₋₁₈. The alkyl chain may be branched or linear, wherein when present, the branches comprise a C₁₋₄ alkyl moiety, such as methyl (C₁) or ethyl (C₂). One of skill in the art will also recognize that the corresponding alkyl glyceryl sulfate surfactant oligomers may also have similar structures with the SO₃⁻ moiety being an OSO₃⁻ moiety. When present in a detergent composition, the alkyl glyceryl sulfonate surfactant oligomer mixture is present from 0.1% to 10%, 0.5% to 5%, 1.0% to 4% by weight of the detergent composition.

Other sulfate or sulphonate surfactants suitable include mid-chain branched alkyl sulfates as discussed in U.S. Pat. No. 6,020,303 and U.S. Pat. No. 6,060,443; mid-chain branched alkyl alkoxy sulfates as discussed in U.S. Pat. No. 6,008,181 and U.S. Pat. No. 6,020,303; modified alkylbenzene sulfonate (MLAS) as discussed in WO 99/05243, WO 99/05242, WO 99/05244, WO 99/05082, WO 99/05084, WO 99/05241, WO 99/07656. WO 00/23549, and WO 00/23548; methyl ester sulphonate (MES); and alpha-olefin sulphonate (AOS).

### Nonionic Surfactants

Nonionic surfactants which may be included are the condensation products of aliphatic alcohols with from about 1 to about 25 moles of ethylene oxide. The alkyl chain of the aliphatic alcohol can either be straight or branched, primary or secondary, and generally contains from about 8 to about 22 carbon atoms. Particularly preferred are the condensation products of alcohols having an alkyl group containing from about 10 to about 20 carbon atoms with from about 2 to about 18 moles of ethylene oxide per mole of alcohol.

Also included are alkylpolyglycosides that may have the formula (III) R²O(CₙH₂ₙO)ₜ(glycosyl)ₓ (III), wherein R² of formula (III) is selected from the group consisting of alkyl, alkyl-phenyl, hydroxyalkyl, hydroxyalkylphenyl, and mixtures thereof in which the alkyl groups contain from about 10 to about 18, further from about 12 to about 14 carbon atoms; n of formula (III) is 2 or 3, further 2; t of formula (III) is from 0 to about 10, further 0; and x of formula (III) is from about 1.3 to about 10, further from about 1.3 to about 3, more further from about 1.3 to about 2.7. The glycosyl is preferably derived from glucose. To prepare these compounds, the alcohol or alkylpolyethoy alcohol is formed first and then reacted with glucose, or a source of glucose, to form the glucoside (attachment at the 1-position). The additional glycosyl units can then be attached between their 1-position and the preceding glycosyl units 2-, 3-, 4- and/or 6-position, preferably predominantly the 2-position.

Further nonionic surfactants that may be include are fatty acid amide surfactants having the formula (IV):

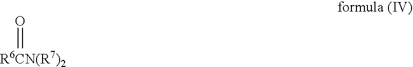

wherein R⁶ of formula (IV) is an alkyl group containing from about 7 to about 21 (preferably from about 9 to about 17) carbon atoms and each R⁷ formula (IV) is selected from the group consisting of hydrogen, C₁-C₄ alkyl, C₁-C₄ hydroxyalkyl, and —(C₂H₄)ₓH where x formula (III) varies from 1 to 3. Preferred amides are C₈-C₂₀ ammonia amides, monoethanolamides, diethanolamides, and isopropanolamides.

Another nonionic surfactant useful in the present composition is 2-ethylhexyl monoglyceryl ether. The glyceryl ether is usually obtained in a method of producing by reacting 2-ethylhexanol with an epoxy compound such as epihalohydrin or glycidol by using an acid catalyst such as BF₃ or an aluminum catalyst. The 2-ethylhexyl monoglyceryl ether is a mixture containing plural products as described in JP-A 2001-49291. Specific examples of 2-ethylhexyl monoglyceryl ether include a compound (3-(2-ethylhexyloxy)-1,2-propanediol in which 2-ethylhexanol is added to the first position of an epoxy compound and a compound (2-(2-ethylhexyloxy)-1,3-propanediol in which 2-ethylhexanol is added to the second position of an epoxy compound. Also, examples of byproducts include multi-addition compounds in which an epoxy compound is further added to the above (3-(2-ethylhexyloxy)-1,2-propanediol and (2-(2-ethylhexyloxy)-1,3-propanediol.

The nonionic surfactant, when present in the composition, is present in an effective amount, such as from about 0.1% to about 40%, further from about 0.1% to about 20%, even further from about 0.5% to about 15%, by weight of the composition.

### Cationic Surfactants/Fabric Softening Additives

Cationic surfactants when utilized as components of the composition of the present application may be selected from non quaternary ammonium surfactants which can have up to 26 carbon atoms that include, but are not limited to alkoxylate quaternary ammonium (AQA) surfactants as discussed in U.S. Pat. No. 6,136,769; dimethyl hydroxyethyl quaternary ammonium as discussed in U.S. Pat. No. 6,004,922; polyamine cationic surfactants as discussed in WO 98/35002, WO 98/35003, WO 98/35004, WO 98/35005, and WO 98/35006; cationic ester surfactants as discussed in U.S. Pat. Nos. 4,228,042, 4,239,660 4,260,529 and U.S. Pat. No. 6,022,844; and amino surfactants as discussed in U.S. Pat. No. 6,221,825 and WO 00/47708, specifically amido propyldimethyl amine.

Suitable cationic surfactants may also be selected from selected from known fabric softening additive including, but not limited to ditallowoyloxyethyl dimethyl ammonium chloride, dihydrogenated-tallowoyloxyethyl dimethyl ammonium chloride, dicanola-oyloxyethyl dimethyl ammonium chloride, ditallow dimethyl ammonium chloride, tritallow methyl ammonium chloride, methyl bis(tallow amidoethyl)-2-hydroxyethyl ammonium methyl sulfate, methyl bis(hydrogenated tallow amidoethyl)-2-hydroxyethyl ammonium methyl sulfate, methyl his (oleyl amidoethyl)-2-hydroxyethyl ammonium methyl sulfate, ditallowoyloxyethyl dimethyl ammonium methyl sulfate, dihydrogenated-tallowoyloxyethyl dimethyl ammonium chloride, dicanola-oyloxyethyl dimethyl ammonium chloride, N-tallowoyloxyethyl-N-tallowoylaminopropyl methyl amine, 1,2-bis(hardened tallowoyloxy)-3-trimethylammonium propane chloride, and mixtures thereof.

Polyquaternary ammonium compounds can also be useful as cationic surfactants in the present compositions and are described in more detail in the following patent documents: EP 803,498; GB 808,265; GB 1,161,552; DE 4,203,489; EP 221,855; EP 503,155; EP 507,003; EP 803,498; FR 2,523,606; JP 84-273918; JP 2-011,545; U.S. Pat. No. 3,079,436; U.S. Pat. No. 4,418,054; U.S. Pat. No. 4,721,512; U.S. Pat. No. 4,728,337; U.S. Pat. No. 4,906,413; U.S. Pat. No. 5,194,667; U.S. Pat. No. 5,235,082; U.S. Pat. No. 5,670,472; Weirong Miao, Wei Hou, Lie Chen, and Zongshi Li, Studies on Multifunctional Finishing Agents, Riyong Huaxue Gonyc, No. 2, pp. 8-10, 1992; Yokagaku, Vol. 41, No. 4 (1992); and Disinfection, Sterilization, and Preservation, 4^{th} Edition, published 1991 by Lea & Febiger, Chapter 13, pp. 226-30. The products formed by quaternization of reaction products of fatty acid with N,N,N′,N′, tetraakis(hydroxyethyl)-1,6-diaminohexane are also suitable for use in the present invention.

Cationic starch based on common maize starch or potato starch, containing 25% to 95% amylose and a degree of substitution of from 0.02 to 0.09, such as that available from Cerestar under the trade name C*BOND® and National Starch under the trade name CATO® A2 may also be utilized as cationic surfactants/fabric softening additives. Also cationic phosphorylated starch such as that discussed in U.S. Pat. No. 4,876,336 (Table II, samples A and F) and in copending application US 2005-0054553, filed Jun. 27, 2004.

Examples of ester and/or amide linked cationic surfactants useful in the present compositions, are disclosed in U.S. Pat. No. 5,759,990 and U.S. Pat. No. 5,747,443. Examples of suitable amine softeners that can be used in the present composition as cationic surfactants are disclosed in U.S. Pat. No. 6,630,441. Other fabric softening actives that can be used herein are disclosed, at least generically for the basic structures, in U.S. Pat. No. 3,861,870; U.S. Pat. No. 4,308,151; U.S. Pat. No. 3,886,075; U.S. Pat. No. 4,233,164; U.S. Pat. No. 4,401,578; U.S. Pat. No. 3,974,076; and U.S. Pat. No. 4,237,016. Examples of more biodegradable cationic surfactants can be found in U.S. Pat. No. 3,408,361; U.S. Pat. No. 4,709,045; U.S. Pat. No. 4,233,451; U.S. Pat. No. 4,127,489; U.S. Pat. No. 3,689,424; U.S. Pat. No. 4,128,485; U.S. Pat. No. 4,161,604; U.S. Pat. No. 4,189,593; and U.S. Pat. No. 4,339,391.

The cationic surfactant, when present in the composition, is present in an effective amount, such as from about 0.11% to about 40%, further from about 1% to about 27%, even further from about 5% to about 20%, by weight of the composition.

### Aqueous Liquid Carrier

The compositions herein when in liquid form may further contain from about 30% to 80% of an aqueous liquid carrier in which the other essential and optional components are dissolved, dispersed or suspended. More preferably the aqueous liquid carrier will comprise from about 45% to about 70%, such as from about 45% to about 65% of the compositions herein.

One preferred component of the aqueous liquid carrier is water. The aqueous liquid carrier, however, may contain other components which are liquid, or which dissolve in the liquid carrier, at room temperature (20° C.-25° C.) and which may also serve some other function besides that of an inert filler. Such materials can include, for example, hydrotropes and solvents, discussed in more detail below. Dependent on the geography of use of the composition herein, the water in the aqueous liquid carrier can have a hardness level of about 2-30 gpg (“gpg” is a measure of water hardness that is well known to those skilled in the art, and it stands for “grains per gallon”).

### Thickness of the Composition

The compositions herein when embodied in a liquid form may be thickened and have viscosity of greater than 700 cps, when measured at 20° C., such as between 700 and 1100 cps.

### Solvent

The compositions herein may optionally comprise a solvent. Suitable solvents include C₄₋₁₄ ethers and diethers, glycols, alkoxylated glycols, C₆-C₁₆ glycol ethers, alkoxylated aromatic alcohols, aromatic alcohols, aliphatic branched alcohols, alkoxylated aliphatic branched alcohols, alkoxylated linear C₁-C₅ alcohols, linear C₁-C₅ alcohols, amines, C₈-C₁₄ alkyl and cycloalkyl hydrocarbons and halohydrocarbons, and mixtures thereof. When branches are present, there may be one or more C₁-C₄ branches.

Preferred solvents are selected from methoxy octadecanol, ethoxyethoxyethanol, benzyl alcohol, 2-ethylbutanol and/or 2-methylbutanol, 1-methylpropoxyethanol and/or 2-methylbutoxyethanol, linear C₁-C₅ alcohols such as methanol, ethanol, propanol, isopropanol, butyl diglycol ether (BDGE), butyltriglycol ether, tert-amyl alcohol, glycerol and mixtures thereof. Particularly preferred solvents which can be used herein are butoxy propoxy propanol, butyl diglycol ether, benzyl alcohol, butoxypropanol, propylene glycol, glycerol, ethanol, methanol, isopropanol and mixtures thereof.

Other suitable solvents for use herein include propylene glycol derivatives such as n-butoxypropanol or n-butoxypropoxypropanol, water-soluble CARBITOL R® solvents or water-soluble CELLOSOLVE R® solvents. Water-soluble CARBITOL R® solvents are compounds of the 2-(2-alkoxyethoxy)ethanol class wherein the alkoxy group is derived from ethyl, propyl or butyl; a preferred water-soluble CARBITOL® is 2-(2-butoxyethoxy)ethanol, also known as BUTYL CARBITOL®. Water-soluble CELLOSOLVE R® solvents are compounds of the 2-alkoxyethoxy ethanol class, with 2-butoxyethoxyethanol being preferred. Other suitable solvents include benzyl alcohol, and diols such as 2-ethyl-1,3-hexanediol and 2,2,4-trimethyl-1,3-pentanediol and mixtures thereof. Some preferred solvents for use herein are n-butoxypropoxypropanol, 2-(2-butoxyethoxy)ethanol and mixtures thereof.

The solvents can also be selected from the group of compounds comprising ether derivatives of mono-, di- and tri-ethylene glycol, butylene glycol ethers, and mixtures thereof. The weight average molecular weights of these solvents are preferably less than 350, such as between 100 and 300, further such as between 115 and 250. Examples of preferred solvents include, for example, mono-ethylene glycol n-hexyl ether, mono-propylene glycol n-butyl ether, and tri-propylene glycol methyl ether. Ethylene glycol and propylene glycol ethers are commercially available from the Dow Chemical Company under the tradename DOWANOL® and from the Arco Chemical Company under the tradename ARCOSOLV®. Other preferred solvents including mono- and di-ethylene glycol n-hexyl ether are available from the Union Carbide Corporation.

When present, the compositions herein will contain 0.01%-20%, such as 0.5%-20%, further 1%-10% by weight of the composition of a solvent. The solvents may be used in conjunction with an aqueous liquid carrier, such as water, or they may be used without any aqueous liquid carrier being present.

### Hydrotrope

The compositions herein may optionally comprise a hydrotrope in an effective amount so that the compositions are appropriately compatible in water. By “appropriately compatible in water”, it is meant that the product dissolves quickly enough in water as dictated by both the washing habit and conditions of use. Compositions that do not dissolve quickly in water can lead to negatives in performance regarding overall cleaning, sudsing, and ease of rinsing of the composition from surfaces such as dishes/glasses etc. or compositions remaining on surfaces after washing. Inclusion of hydrotropes also serves to improve composition stability and formulatibility as is well known in the literature and prior art.

Suitable hydrotropes for use herein include anionic-type hydrotropes, particularly sodium, potassium, and ammonium xylene sulfonate, sodium, potassium and ammonium toluene sulfonate, sodium potassium and ammonium cumene sulfonate, and mixtures thereof; and related compounds, as disclosed in U.S. Pat. No. 3,915,903.

The compositions herein typically comprise from 0% to 15% by weight of the composition of a hydrotropic, or mixtures thereof, preferably from 1% to 10%, most preferably from 3% to 6% by weight of the composition.

### Hydrophobic Block Polymer

The compositions herein may optionally comprise a hydrophobic block polymer having alkylene oxide moieties and a weight average molecular weight of at least 500, but preferably less than 10,000, such as from 1000 to 5000 and further from 1500 to 3500. Suitable hydrophobic polymers have a water solubility of less than about 1%, such as less than about 0.5%, further less than about 0.1% by weight of the polymer at 25° C.

“Block polymers” as used herein is meant to encompass polymers including two or more different homopolymeric and/or monomeric units which are linked to form a single polymer structure. Preferred copolymers comprise ethylene oxide as one of the monomeric units. More preferred copolymers are those with ethylene oxide and propylene oxide. The ethylene oxide content of such preferred polymers is more than about 5 wt %, and more preferably more than about 8 wt %, but less than about 50 wt %, and more preferably less than about 40 wt %. A preferred polymer is ethylene oxide/propylene oxide copolymer available from BASF under the tradename PLURONIC L81®, PLURONIC L35® or PLURONIC L43®.

The compositions herein optionally comprise from 0% to 15% by weight of the composition of one or more hydrophobic block polymer(s), preferably from 1% to 10%, most preferably from 1% to 6% by weight of the composition.

### Thickening Agent

The compositions herein can also contain from about 0.2% to 5% by weight of the detergent composition of a thickening agent. More preferably, such a thickening agent will comprise from about 0.5% to 2.5% of the detergent compositions herein. Thickening agents are typically selected from the class of cellulose derivatives. Suitable thickeners include hydroxy ethyl cellulose, hydroxyethyl methyl cellulose, carboxy methyl cellulose, cationic hydrophobically modified hydroxyethyl cellulose, available from Amerchol Corporation as QUATRISOFT® LM200, and the like. A preferred thickening agent is hydroxypropyl methylcellulose.

### Polymeric Suds Stabilizer

The compositions herein may optionally contain a polymeric suds stabilizer. These polymeric suds stabilizers provide extended suds volume and suds duration of the compositions. These polymeric suds stabilizers may be selected from homopolymers of (N,N-dialkylamino) alkyl esters and (N,N-dialkylamino)alkyl acrylate esters. The weight average molecular weight of the polymeric suds boosters, determined via conventional gel permeation chromatography, is from 1,000 to 2,000,000, such as from 5,000 to 1,000,000, further from 10,000 to 750,000, further still from 20,000 to 500,000, even further from 35,000 to 200,000. The polymeric suds stabilizer can optionally be present in the form of a salt, either an inorganic or organic salt, for example the citrate, sulfate, or nitrate salt of (N,N-dimethylamino)alkyl acrylate ester.

One preferred polymeric suds stabilizer is (N,N-dimethylamino)alkyl acrylate esters, namely the acrylate ester represented by the formula (V):

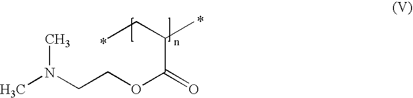

When present in the composition, the polymeric suds booster may be present in the composition from 0.01% to 15%, such as from 0.05% to 10%, further from 0.1% to 5%, by weight of the composition.

### Diamines

Another optional ingredient of the compositions herein is a diamine. Since the habits and practices of the users of compositions such as liquid dishwashing detergent compositions show considerable variation, the composition may contain 0%-15%, such as 0.1%-15%, further 0.2%-10%, further such as 0.25%-6%, also 0.5%-1.5% by weight of said composition of at least one diamine.

Preferred organic diamines include 1,3-bis(methylamine)-cyclohexane (pKa=10 to 10.5), 1,3 propane diamine (pK1=10.5; pK2=8.8), 1,6 hexane diamine (pK1=11; pK2=10), 1,3 pentane diamine (DYTEK EP®) (pK1=10.5; pK2=8.9), 2-methyl 1,5 pentane diamine (DYTEK A®) (pK1=11.2; pK2=10.0). Other preferred materials include primary/primary diamines with alkylene spacers ranging from C₄ to C₈. In general, it is believed that primary diamines are preferred over secondary and tertiary diamines. As a working definition herein, the pKa of the diamines is specified in an all-aqueous solution at 25° C. and for an ionic strength between 0.1 to 0.5 M.

Preferably, the compositions herein when in liquid form are formulated as clear liquid compositions. By “clear” it is meant stable and transparent. In order to achieve clear compositions, the use of solvents and hydrotropes is well known to those familiar with the art of detergent compositions. Preferred compositions herein are clear single phase liquids, but also embraces clear and opaque products containing dispersed phases, such as beads or pearls as described in U.S. Pat. No. 5,866,529, to Erilli, et al., and U.S. Pat. No. 6,380,150, to Toussaint, et al., provided that such products are physically stable (i.e., do not separate) on storage.

The compositions herein may be packages in any suitable packaging for delivering the composition for use. Preferably the package is a clear package made of glass or plastic.

### Builder

The compositions according to the present application may further comprise a builder system. If it is desirable to use a builder, then any conventional builder system is suitable for use herein including aluminosilicate materials, silicates, polycarboxylates and fatty acids, materials such as ethylene-diamine tetraacetate, metal ion sequestrants such as aminopolyphosphonates, particularly ethylenediamine tetramethylene phosphonic acid and diethylene triamine pentamethylene-phosphonic acid. Though less preferred for obvious environmental reasons, phosphate builders can also be used herein.

Suitable polycarboxylates builders for use herein include citric acid, preferably in the form of a water-soluble salt, derivatives of succinic acid of the formula (VI) R—CH(COOH)CH₂(COOH) (formula VI) wherein R of formula (VI) is C₁₀₋₂₀ alkyl or alkenyl, such as C₁₂₋₁₆, or wherein R of formula (VI) can be substituted with hydroxyl, sulfo sulfoxyl or sulfone substituents. Specific examples include lauryl succinate, myristyl succinate, palmityl succinate 2-dodecenylsuccinate, 2-tetradecenyl succinate. Succinate builders are preferably used in the form of their water-soluble salts, including sodium, potassium, ammonium and alkanolammonium salts.

Other suitable polycarboxylates are oxodisuccinates and mixtures of tartrate monosuccinic and tartrate disuccinic acid such as described in U.S. Pat. No. 4,663,071.

Especially for the liquid form herein, suitable fatty acid builders for use herein are saturated or unsaturated C₁₀₋₁₈ fatty acids, as well as the corresponding soaps. Preferred saturated species have from 12 to 16 carbon atoms in the alkyl chain. The preferred unsaturated fatty acid is oleic acid. Other preferred builder system for liquid compositions is based on dodecenyl succinic acid and citric acid.

If builder is included, it may be included in amounts of from 0.5% to 50% by weight of the composition preferably from 0.5% to 25% and most usually from 0.5% to 5% by weight.

### Enzymes

The compositions of the present application may further comprise one or more enzymes which provide cleaning performance benefits. Said enzymes include enzymes selected from cellulases, hemicellulases, peroxidases, proteases, gluco-amylases, amylases, lipases, cutinases, pectinases, xylanases, reductases, oxidases, phenoloxidases, lipoxygenases, ligninases, pullulanases, tannases, pentosanases, malanases, β-glucanases, arabinosidases or mixtures thereof. A preferred combination is a composition having a cocktail of conventional applicable enzymes like protease, amylase, lipase, cutinase and/or cellulase. Enzymes when present in the compositions, at from 0.0001% to 5% of active enzyme by weight of the composition. Preferred proteolytic enzymes, then, are selected from the group consisting of ALCALASE® (Novo Industri A/S), BPN″, Protease A and Protease B (Genencor), and mixtures thereof. Protease B is most preferred. Preferred amylase enzymes include TERMAMYL®, DURAMYL® and the amylase enzymes those described in WO 9418314 to Genencor International and WO 9402597 to Novo.

### Chelating Agents

The compositions herein may also optionally contain one or more iron and/or manganese chelating agents. Such chelating agents can be selected from the group consisting of amino carboxylates, amino phosphonates, polyfunctionally-substituted aromatic chelating agents and mixtures therein, all as hereinafter defined. Without intending to be bound by theory, it is believed that the benefit of these materials is due in part to their exceptional ability to remove iron and manganese ions from washing solutions by formation of soluble chelates.

Amino carboxylates useful as optional chelating agents include ethylene diamine tetracetates, N-hydroxy ethyl ethylene diamine triacetates, nitrilo-tri-acetates, ethylenediamine tetraproprionates, triethylene tetraamine hexacetates, diethylene triamine pentaacetates, and ethanol diglycines, alkali metal, ammonium, and substituted ammonium salts therein and mixtures therein.

Amino phosphonates are also suitable for use as chelating agents in the compositions of the invention when at lease low levels of total phosphorus are permitted in detergent compositions, and include ethylene diamine tetrakis (methylene phosphonates) as DEQUEST®. Preferred, these amino phosphonates to not contain alkyl or alkenyl groups with more than 6 carbon atoms. Polyfunctionally-substituted aromatic chelating agents are also useful in the compositions herein. See U.S. Pat. No. 3,812,044, issued May 21, 1974, to Connor et al. Preferred compounds of this type in acid form are dihydroxydisulfobenzenes such as 1,2-dihydroxy-3,5-disulfobenzene. A preferred biodegradable chelator for use herein is ethylenediamine disuccinate (“EDDS”), especially the [S,S] isomer as described in U.S. Pat. No. 4,704,233, Nov. 3, 1987, to Hartman and Perkins. The compositions herein may also contain water-soluble methyl glycine diacetic acid (MGDA) salts (or acid form) as a chelant or co-builder. Similarly, the so called “weak” builders such as citrate can also be used as chelating agents.

If utilized, these chelating agents will generally comprise from 0.00015% to 15% by weight of the detergent compositions herein. More preferably, if utilized, the chelating agents will comprise from 0.0003% to 3.0% by weight of such compositions.

### Other Ingredients

The compositions will further preferably comprise one or more detersive adjuncts selected from the following: soil release polymers, polymeric dispersants, polysaccharides, abrasives, bactericides and other antimicrobials, tarnish inhibitors, antifungal or mildew control agents, insect repellents, perfumes, hydrotropes, thickeners, processing aids, suds boosters, brighteners, anti-corrosive aids, stabilizers antioxidants and chelants. A wide variety of other ingredients useful in detergent compositions can be included in the compositions herein, including other active ingredients, carriers, antioxidants, processing aids, solvents for liquid formulations, solid fillers for bar compositions, etc. If high sudsing is desired, suds boosters such as the C₁₀-C₁₆ alkanolamides can be incorporated into the compositions, typically at 1%-10% levels. The C₁₀-C₁₄ monoethanol and diethanol amides illustrate a typical class of such suds boosters. Use of such suds boosters with high sudsing adjunct surfactants such as the amine oxides, betaines and sultaines noted above is also advantageous.

An antioxidant can be optionally added to the compositions of the present application. They can be any conventional antioxidant used in detergent compositions, such as 2,6-di-tert-butyl-4-methylphenol (BHT), carbamate, ascorbate, thiosulfate, monoethanolamine (MEA), diethanolamine, triethanolamine, etc. It is preferred that the antioxidant, when present, be present in the composition from 0.001% to 5% by weight.

### Process of Cleaning Dishware

The present composition also relates to a process for cleaning dishware. The dishware is contacted with a composition as described above. The composition can be mixed with water in a suitable vessel, for example a basin, sink or bowl and thus a number of dishes can be cleaned using the same composition and water (dishwater). In a further alternative process the product can be used in dilute form in a suitable vessel as a soaking medium for, typically extremely dirty, dishware. As before the dishware can be optionally, although preferably, rinsed before allowing to dry. Drying make take place passively by allowing for the natural evaporation of water or actively using any suitable drying equipment, for example a cloth or towel.

### Viscosity Test Method

The viscosity of the detergent composition herein is measured on a Brookfield viscometer model # LVDVII+ at 20° C. The spindle used for these measurements is S31 with the appropriate speed to measure products of different viscosities; e.g., 12 rpm to measure products of viscosity greater than 1000 cps; 30 rpm to measure products with viscosities between 500 cps-1000 cps; 60 rpm to measure products with viscosities less than 500 cps.

The following examples, whilst being representative of the compositions of the present invention are in no way meant to be limiting.

TABLE 1
Liquid Dishwashing Detergent Composition

| Composition | A (wt %) | B (wt %) | C (wt %) | D (wt %) |
|---|---|---|---|---|
| Sodium Citrate•2H2O | 0 | 0 | 2.0 | 0 |
| SCS¹ | 0 | 0 | 3.0 | 0 |
| PolyPropylene Glycol 2000 | 0.4 | 0.2-0.4 | 0.2-0.4 | 0.2 |
| Ethanol | 3.5 | 3.0-4.0 | 3.5-4.5 | 0-4.5 |
| NaCl | 1.0 | 1.0-1.4 | 1.0-1.4 | 1.0-1.4 |
| Amine Oxide² | 4.0-8.0 | 4.0-8.0 | 4.0-8.0 | 4.0-8.0 |
| Anionic (AE0.6S)³ | 15.0-30.0 | 15.0-30.0 | 15.0-30.0 | 15.0-30.0 |
| 1,3 BAC⁴ | 0.2-0.3 | 0.2-0.3 | 0.2-0.3 | 0.2-0.3 |
| Suds boosting polymer⁵ | 0.2 | 0.2 | 0 | 0 |
| Cleaning polymer⁶ | 0-0.6 | 0-0.6 | 0-0.6 | 0-0.6 |
| pH Dye | 25-180 ppm | 25-180 ppm | 25-180 ppm | 25-180 ppm |
| Water and any desired | | | | |
| optional ingredience to balance | | | | |
| pH @10% | 9 | 9 | 9 | 9 |

¹Sodium Cumene Sulphonate
²C₁₂-C₁₄ Amine oxide.
³C₁₂₋₁₃ alkyl ethoxy sulfonate containing an average of 0.6 ethoxy groups.
⁴1,3, BAC is 1,3 bis(methylamine)-cyclohexane.
⁵(N,N-dimethylamino)ethyl methacrylate homopolymer
⁶such as those discussed in US 2006/0073999A1

TABLE 2
Liquid Laundry Cleaning Composition

| | A |
|---|---|
| Ingredients | [% by wt.] |
| Linear | 10-15 |
| alkylbenzenesulfonate | |
| C₁₂₋₁₅ alcohol ethoxy_{(1.1-2.5)} | 1-5 |
| sulfate | |
| C₁₂₋₁₃ alcohol | 1-5 |
| ethoxylate₍₇₋₉₎ | |
| cocodimethyl amine | 0-1 |
| oxide | |
| fatty acid | 1-5 |
| citric acid | 1-5 |
| Polymer a¹ | 0.1-1.5 |
| Polymer b² | 0.1-1.5 |
| pH dye | 25-180 ppm |
| hydroxylated castor oil | 5-20 |
| (structurant) | |
| Water, perfumes, other | ad 100 |
| dyes, and other trace | |
| components | |

¹one or more polymers according to U.S. Pat. No. 4,891,160, VanderMeer, et al.
²one or more polymers according to WO 00/105923, Price, et al.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid composition system comprising:
(a) a liquid composition with a pH of from 7.5 to 13 comprising:
(i) a pH dye capable of a first visual indication and capable of a second visual indication;
(ii) an amphoteric surfactant, preferably an amine oxide surfactant; and
(b) a volume of water;
wherein the liquid composition comprising the first visual indication of the pH dye and when the liquid composition is diluted in a volume of water forming a liquid composition system and the liquid composition system comprises the second visual indication of the pH dye.

2. The liquid composition system of claim 1 wherein the pH of the liquid composition system is less than the pH of the liquid composition.

3. The liquid composition system of claim 1 wherein the liquid composition comprises two or more pH dyes.

4. The liquid composition system of claim 1 wherein the liquid composition further comprises one or more dyes that are not pH dyes.

5. The liquid composition system of claim 1 wherein the pH dye selected from: 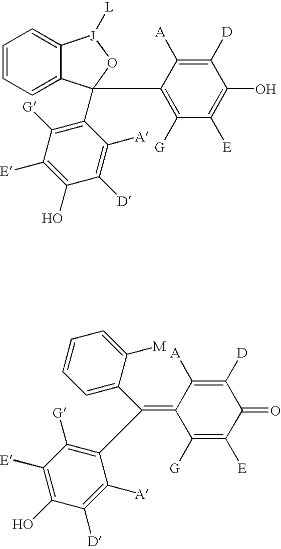
and mixtures thereof, wherein A and A′ are independently selected from hydrogen, linear or branched C₁-C₁₂ alkyl, D and D′ are independently selected from hydrogen, linear or branched C₁-C₁₂ alkyl, chlorine and bromine, E and E′ are independently selected from hydrogen, linear or branched C₁-C₁₂ alkyl, chlorine and bromine, G and G′ are independently selected from hydrogen, chlorine or bromine, J-L is a —C═O or —SO₂ and M is selected from SO₃⁻, CO₂⁻ and mixtures thereof.

6. The liquid composition system of claim 1 wherein the pH dye is selected from the group of bromocresol purple, bromothymol blue, bromocresol green, bromophenol blue, bromoxylenol blue and mixtures thereof.

7. The liquid composition system of claim 1 wherein the liquid composition further comprises an anionic surfactant.

8. The liquid composition system of claim 7 wherein the anionic surfactant is a sulfate or sulphonate surfactant.

9. The liquid composition system of claim 1 wherein the liquid composition further comprises a nonionic surfactant.

10. The liquid composition system of claim 1 wherein the first visual indication is selected from yellow or green.

11. The liquid composition system of claim 1 wherein the second visual indication is a blue color.

12. A method of producing a color change in a liquid detergent composition by providing a liquid composition with a pH of from 7.5 to 13 having a first visual color comprising: (i) a pH sensitive dye; (ii) an amine oxide surfactant; such that when the liquid detergent composition is added to a volume of water a second visual color results.

13. A process of producing a visual change in the color of a liquid composition comprising the steps of:
(a) providing a liquid composition with a pH of from 7.5 to 13 having a first visual color comprising:
(i) a pH sensitive dye;
(ii) an amine oxide surfactant;
(b) providing instructions to add the liquid composition to a volume of water; and
(c) communicating that the mixture resulting from the liquid composition and volume of water results a second visual color.
